(19) United States
(12) Patent Application Publication
(10) Pub. No.: US 2026/0335916 A1
(43) Pub. Date: Oct. 29, 2026

(54) PRODUCT DISPENSING DEVICE HAVING A HELICAL BELLOWS

(71) Applicant: PROMENS SA, BELLIGNAT (FR)

(72) Inventors: Gwénaël DOULIN, SAINTE EUPHEMIE (FR); Pascal HENNEMANN, VAUX-LES-SAINT-CLAUDE (FR)

(21) Appl. No.: 19/106,187

(22) PCT Filed: Aug. 25, 2023
(86) PCT No.: PCT/FR2023/051292

§ 371 Date: Feb. 24, 2025

(30) Foreign Application Priority Data
Aug. 30, 2022 (FR) FR2208687

(51) Int. Cl. B05B 11/10; A45D 34/00; F04B 9/14; F04B 13/00

(52) U.S. Cl. CPC B05B 11/1035; A45D 34/00; B05B 11/1066; F04B 9/14; F04B 13/00

(57) ABSTRACT

Please delete the abstract in its entirety and replace with the following:

A device for dispensing a liquid to pasty product includes a pump body, a push-button slidably mounted in the pump body, a dispensing duct arranged in the push-button, a metering chamber, an elastically deformable bellows, an inlet valve, an outlet valve, an intermediate cavity, characterized in that the outlet valve is mounted so as to slide axially on the push-button between an upper position and a lower position, so as to cause a suction effect sucking the product from the dispensing duct towards the intermediate cavity when the push-button slides from a dispensing position to an inactive position.

### TECHNICAL FIELD OF THE INVENTION

The present invention relates to the field of devices for dispensing for a liquid to pasty to be dispensed, in particular a cream, ointment or paste, especially for cosmetic use.

The invention relates more particularly to dispensing devices which fit onto the neck of a container containing a liquid or cream.

### TECHNICAL BACKGROUND

It is known in the prior art, for example WO2019/102106A1, that dispensing devices can be mounted on the neck of a container containing a liquid or cream, comprising a pump motor with a metering chamber, for example delimited by a bellows. An inlet valve and an outlet valve open and close the inlet and outlet of this chamber, respectively.

When the pump is activated by pressing the push-button, pressure is generated inside the pump which, on the one hand, opens the outlet valve and allows the product to flow out, and on the other hand, closes the inlet valve and prevents it from flowing back into the container. When the push-button is released, the bellows forms an elastic return means, generating a return force on the push-button, which then moves upwards. As the bellows expand, they generate a vacuum inside the pump. On the one hand, this vacuum causes the inlet valve to open, allowing the product contained in the container to be sucked into the metering chamber. On the other hand, it closes the outlet valve and prevents air from being sucked into the device.

To ensure proper operation of the dispensing device, it is not easy to find the optimum compromise between the rigidity and flexibility of the flexible elements forming the pump motor, in order to guarantee ergonomic actuation by the user and precise dispensing of the product dose. Furthermore, once the product dose has been dispensed, a small amount of product usually remains in the pump's dispensing duct, between the metering chamber and the external orifice. This product residue can dry out between two uses of the pump and form a plug of dry product.

There is therefore a need to improve existing dispensing systems.

### SUMMARY OF THE INVENTION

The invention provides a device for dispensing a liquid to pasty product, comprising:
a pump body intended to be mounted on a product reservoir,
a push-button slidably mounted in the pump body along a main axis between an inactive axial position and a dispensing axial position,
a dispensing duct arranged in the push-button so as to enable a dose of product to be dispensed,
a variable-volume metering chamber comprising a chamber inlet in communication with a supply duct intended to be connected to the reservoir, and a chamber outlet in communication with the dispensing duct,
an elastically deformable bellows which laterally delimits the metering chamber and elastically biases the push-button towards its inactive position,
a first non-return valve, known as an inlet valve, arranged to open or close the chamber inlet under the effect of a pressure decrease or increase, respectively, in the metering chamber,
a second non-return valve, known as an outlet valve, located between the chamber outlet and the dispensing duct,
an intermediate cavity arranged between the dispensing duct and the outlet valve so as to be able to store a given quantity of product, characterized in that the outlet valve is mounted so as to slide axially on the push-button between an upper position and a lower position, so as to cause a suction effect sucking the product from the dispensing duct towards the intermediate cavity when the push-button slides from its dispensing position to its inactive position.

According to other features of the invention:
the outlet valve comprises a tubular body which is axially slidably mounted on an internal cylindrical portion of the push-button;
the tubular body includes at least one stop surface intended to engage with an associated bearing surface arranged on the inner cylindrical portion of the push-button in order to define the lower position;
the tubular body and the inner cylindrical portion of the push-button each have an undercut portion which forms the stop surface and the bearing surface, respectively;
the tubular body of the outlet valve includes an upper cylindrical end portion which is axially received in an annular slot delimited inwardly by the inner cylindrical portion and outwardly by a peripheral cylindrical wall of the push-button;
the outlet valve includes a peripheral lip which extends from the outer wall of the tubular body and abuts an associated surface of the bellows in the closed position;
the bellows has at least one internal shoulder portion on the side of its upper axial end, and the peripheral lip rests at least partly on said internal shoulder portion when the push-button occupies a locked angular position;
the bellows comprises an upper flange designed to bear axially against an upper rim formed in the push-button and an upper tubular extension which includes a window designed to be aligned radially with the dispensing duct, in an unlocked angular position of the push-button, and designed to be offset radially with respect to the dispensing duct, in a locked angular position of the push-button, so that the upper tubular extension closes the dispensing duct on the inside in the locked position;
the upper end wall of the push-button is inclined at a downward slope towards the side opposite the dispensing duct, and the upper tubular extension has a beveled shape at its upper free end so that the uppermost part of the upper tubular extension is generally radially aligned with the dispensing duct when the push-button occupies its locked position;
the bellows includes, in the vicinity of its lower end, a lower flange designed to bear axially against a lower rim formed in the pump body, and a lower tubular extension which is tightly fitted in an annular housing formed in the pump body;
each flange comprises at least one keying element which is intended to engage with a complementary keying element formed in the pump body, so as to allow only one angular mounting position of the bellows in the pump body;
the keying elements of the flanges each consist of two opposing notches, and the notches of the upper flange are radially aligned with the notches of the lower flange;
the pump body has two partially cylindrical axial tongues whose circumferential dimension is substantially equal to the circumferential dimension of each notch formed in the lower flange, so as to prevent pivoting about the main axis of the lower flange;
the bellows are formed of helically wound beads.

### BRIEF DESCRIPTION OF THE FIGURES

Further features and advantages of the invention will become apparent from the following detailed description, which may be understood with reference to the attached drawings in which:

FIG. 1 is an exploded perspective view schematically showing a dispensing device in accordance with the teachings of the invention and an associated reservoir;

FIG. 2 is a cross sectional view along plane 2-2 which schematically shows the dispensing device of FIG. 1 when the push-button is in a locked and inactive position;

FIG. 3 is a cross sectional view along plane 3-3 which schematically shows the dispensing device of FIG. 2 when the push-button is in an unlocked and inactive position;

FIG. 4 is a view similar to that of FIG. 3, which schematically shows the dispensing device of FIG. 2 when the push-button occupies an intermediate actuating position after an axial displacement of the push-button by an axial travel corresponding to the relative displacement of the outlet valve with respect to the push-button from a lower stop position to an upper stop position, the product not having begun to fill the dispensing duct;

FIG. 5 is a view similar to that of FIG. 3, which schematically shows the dispensing device of FIG. 2 when the push-button is in its lowered position, wherein the bellows fitted thereto are compressed and the product has been expelled from the metering chamber through the dispensing duct;

FIG. 6 is a view similar to that of FIG. 3, which schematically shows the dispensing device of FIG. 2 at the start of the return to the inactive position, the push-button having moved a distance corresponding to the axial travel allowing the outlet valve, which does not move at this stage, to return to its lower stop position, causing the product contained in the dispensing duct to be sucked towards an intermediate cavity;

FIG. 7 is a view similar to that of FIG. 3, which schematically shows the dispensing device of FIG. 2 at the end of the push-button's ascent to its upper inactive position;

FIG. 8 is a view similar to the one shown in FIG. 2 which shows the locking of the dispensing device shown in FIG. 2;

FIG. 9 is a side view and FIG. 12 is a top view showing the bellows fitted to the dispensing device of FIG. 1 before assembly;

FIG. 10 is a view similar to that of FIG. 9 and FIG. 13 is a view similar to that of FIG. 12 which show the bellows in a slightly compressed state corresponding to its mounted state in the dispensing device before push-button actuation;

FIG. 11 is a view similar to FIG. 9 and FIG. 14 is a view similar to FIG. 12 which show the bellows in a compressed state corresponding to the lowered position of the push-button;

FIG. 15 is a view similar to that shown in FIG. 12, which shows a variant of the dispensing device where the reservoir includes a non-return valve that allows it to be vented.

### DETAILED DESCRIPTION OF THE INVENTION

In the following description, identical, similar or analogous elements will be referred to by the same reference numbers.

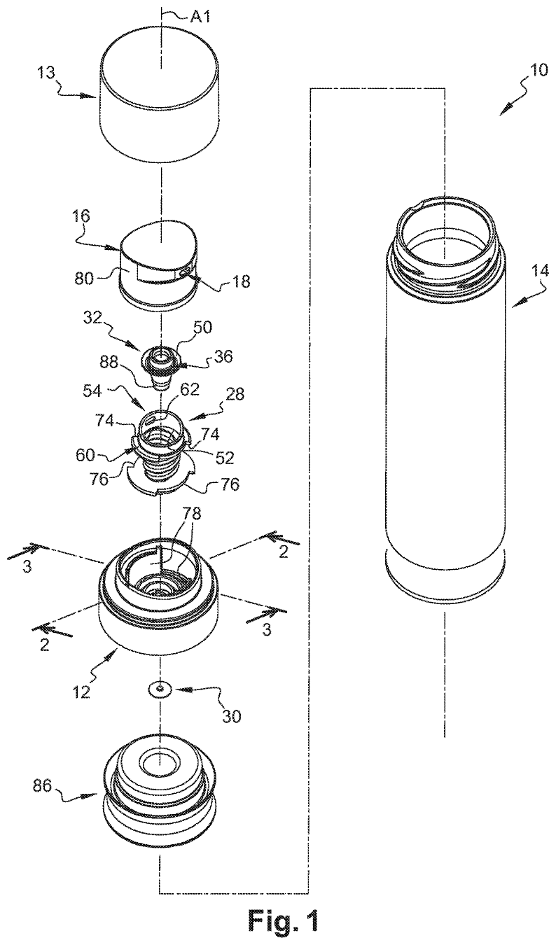

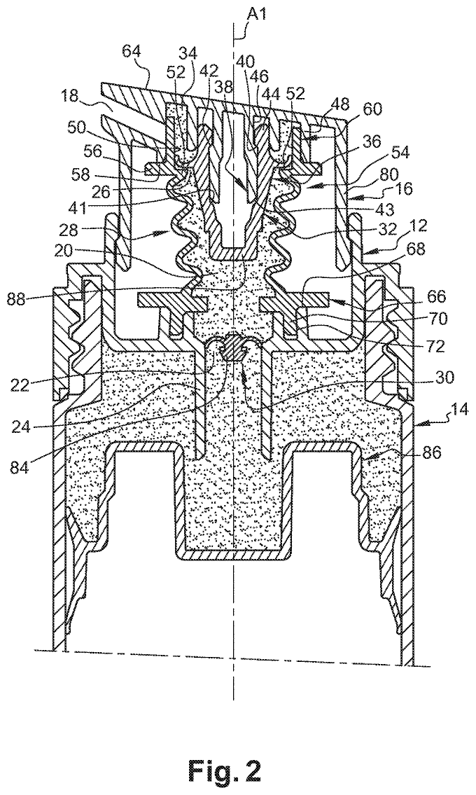

FIGS. 1 and 2 show a device 10 for dispensing a liquid to pasty product, or pump, in accordance with the teachings of the invention. The dispensing device 10 comprises a pump body 12 which is intended to be mounted on a product reservoir 14, for example by screwing.

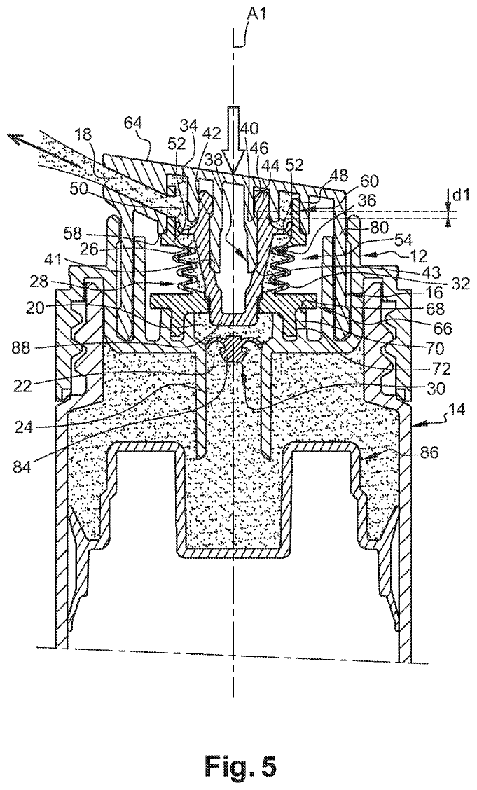

The dispensing device 10 comprises a push-button 16 slidably mounted in the pump body 12, along a main axis A1, between an inactive axial position, which is shown in FIG. 2, and a dispensing axial position, which is shown in FIG. 5.

FIG. 1 shows a protective cover 13 which is intended to be mounted on the reservoir 14 to protect the push-button 16 and a product dispensing orifice.

FIGS. 2 to 8 show various axial and angular operating positions, which will be explained later.

In the remainder of this description, elements will be referred to non-limitingly as upper or lower, conventionally considering a vertical orientation along the main axis A1.

A dispensing duct 18 is arranged in the push-button 16 to enable a dose of product to be dispensed from a variable-volume metering chamber 20.

The metering chamber 20 is interposed between the dispensing duct 18 located downstream of the product dispensing circuit, and the reservoir 14 located upstream of the product dispensing circuit.

The metering chamber 20 includes a chamber inlet 22 in communication with a supply duct 24 intended to be connected to the reservoir 14, and a chamber outlet 26 in communication with the dispensing duct 18.

The supply duct 24 is formed of a tube molded in one piece with the pump body 12, along the main axis A1, and is submerged in the reservoir 14 to enable the product to be dispensed.

The dispensing device 10 also includes an elastically deformable bellows 28, which laterally delimits the metering chamber 20 and elastically biases the push-button 16 towards its inactive position, in this case upwards. The bellows 28 is preferably molded in one piece from elastomer material.

A first non-return valve, known as an inlet valve 30, is arranged to open or close the chamber inlet 22 under the effect of a pressure decrease or increase, respectively, in the metering chamber 20.

A second non-return valve, called an outlet valve 32, is arranged between the chamber outlet 26 and the dispensing duct 18, so as to open the chamber outlet 26 when a dose of product is dispensed and to close the chamber outlet 26 at the end of this dispensing.

An intermediate cavity 34 is arranged between the dispensing duct 18 and the outlet valve 32 so that a certain quantity of product can be stored.

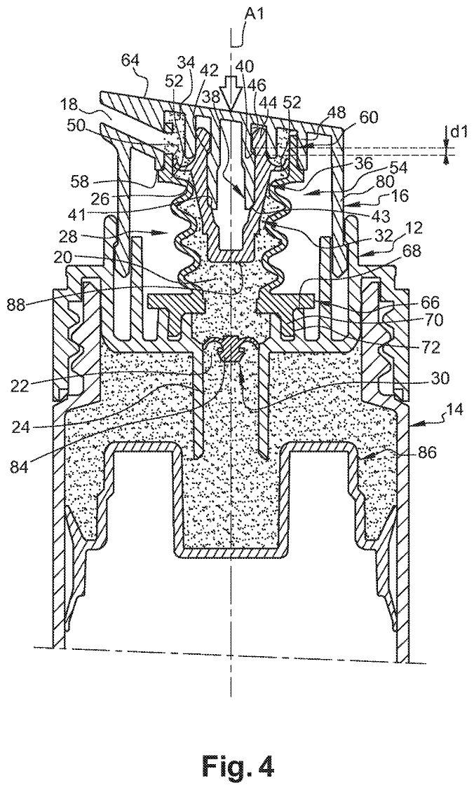

Advantageously, the outlet valve 32 is axially slidably mounted on the push-button 16 between an upper position, which is shown in particular in FIG. 4, and a lower position, which is shown in particular in FIG. 2. The sliding of the outlet valve 32 creates a suction effect, sucking the product from the dispensing duct 187 towards the intermediate cavity 34 when the push-button 16 slides from its dispensing position to its inactive position.

According to the embodiment shown here, the outlet valve 32 includes a tubular body 36 which is axially slidably mounted on an internal cylindrical portion 38 of the push-button 16. The tubular body 36 includes a first stop surface 40 which is intended to engage with an associated first bearing surface 42 arranged on the inner cylindrical portion 38 of the push-button 16 in order to define the lower position, and a second stop surface 41 which is intended to engage with an associated second bearing surface 43 arranged on the inner cylindrical portion 38 in order to define the upper position.

The tubular body 36 and the inner cylindrical portion 38 of the push-button 16 each have an undercut portion which forms the first stop surface 40 and the first bearing surface 42, respectively.

The stop surfaces 40, 41 and the bearing surfaces 42, 43 define an axial travel d1 of the outlet valve 32 relative to the push-button 16, the function of which will be described later.

The tubular body 36 of the outlet valve 32 includes an upper cylindrical end portion 44 which is axially received in an annular slot 46 delimited inwardly by the inner cylindrical portion 38 and outwardly by a peripheral cylindrical wall 48 of the push-button 16.

Note that the intermediate cavity 34 here is annular in shape, extending around the tubular body 36 of the outlet valve 32 and around the peripheral cylindrical wall 48 of the push-button 16.

According to the embodiment shown, the outlet valve 32 includes a peripheral lip 50 which extends from the outer wall of the tubular body 36 and abuts an associated surface of the bellows 28 in the closed position. The peripheral lip 50 is mounted here curved upwards, inside the bellows. It is designed to rest elastically against the bellows 28 so as to be able to yield by elastic deformation when the product to be dispensed needs to pass towards the intermediate cavity 34 and the dispensing duct 18, and so as to seal the metering chamber 20 in other cases.

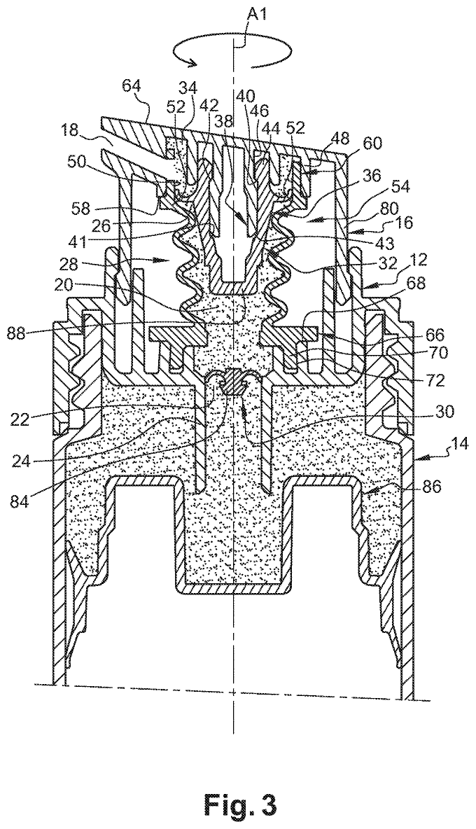

Preferably, the push-button 16 is pivotally mounted about the main axis A1, relative to the pump body 12, between a locked angular position, which is shown in FIG. 2, and an unlocked angular position, which is shown in FIGS. 3 to 7.

In the locked angular position, the passage between the intermediate cavity 34 and the dispensing duct 18 is sealed to prevent contamination of the product contained in the intermediate cavity 34 by contaminants in the outside air, and to limit interactions with the outside environment (anti-drying, dust, etc.). In addition, the push-button 16 is locked against axial sliding, thus preventing any unwanted manipulation. To achieve this locking, suitable locking members (not shown) can be arranged in the pump body 12 and in the push-button 16, these locking members being retracted in the unlocked angular position.

In the unlocked angular position, the passage between the intermediate cavity 34 and the dispensing duct 18 is open to enable a dose of product to be dispensed, and the push-button 16 is free to slide axially.

Advantageously, the bellows 28 has at least one internal shoulder portion 52, on the side of its upper axial end 54. The peripheral lip 50 is designed to rest at least partly on the internal shoulder portion 52 when the push-button 16 occupies its locked angular position.

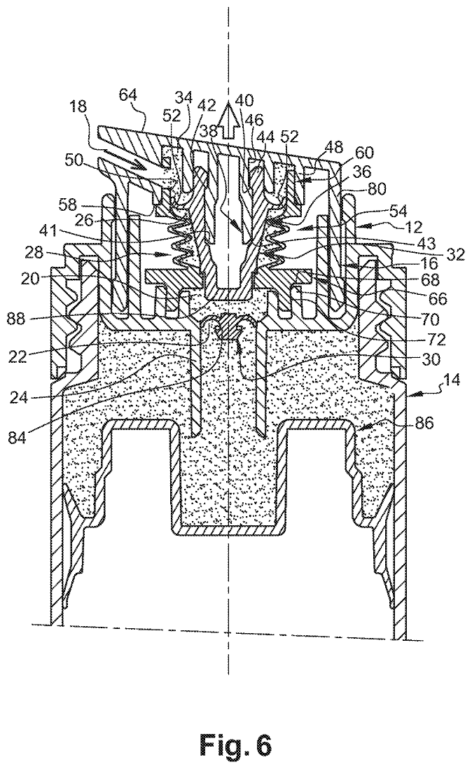

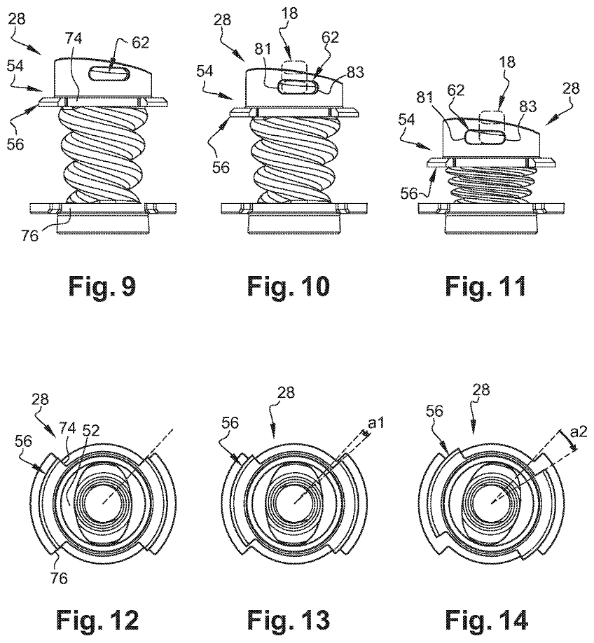

FIGS. 9 to 14 show the bellows 28 in several positions. FIGS. 9 and 12 show the bellows 28 before mounting in the dispenser 10. FIGS. 10 and 13 show the bellows 28 in a slightly axially compressed state, when it is mounted in the dispensing device 10 and the latter occupies its unlocked angular position, prior to actuation of the dispensing device 10, as shown in FIG. 3. FIGS. 11 and 14 show bellows 28 in an axially compressed state corresponding to the lower position of push-button 16, as shown in FIG. 6.

According to the embodiment shown, the bellows 28 includes an upper flange 56 designed to bear axially against an upper rim 58 formed in the push-button 16, and an upper tubular extension 60 comprising a window 62 designed to be radially aligned with the dispensing duct 18, in the unlocked angular position of the push-button 16. The window 62 thus forms a passage for the product to be dispensed between the dispensing duct 18 and the intermediate cavity 34. In the locked angular position of the push-button 16, the window 62 is radially offset from the dispensing duct 18, so that the upper tubular extension 60 closes the dispensing duct 18 on the inside.

According to the embodiment shown, the upper end wall 64 of the push-button 16 slopes downwards away from the dispensing duct 18. The upper tubular extension 60 of the bellows 28 has a beveled shape at its upper free end so that the uppermost part of the upper tubular extension 60 is generally radially aligned with the dispensing duct 18 when the push-button 16 occupies its locked position. The height of the beveled shape is adjusted in relation to the upper end wall 64 of the push-button 16 so that angular pivoting of the push-button 16 is not impeded by mechanical interference between the bellows 28 and the push-button 16.

Preferably, in the vicinity of its lower end, the bellows 28 has a lower flange 66 designed to bear axially against a lower rim 68 formed in the pump body 12. The bellows 28 also includes a lower tubular extension 70 which is tightly fitted in an annular housing 72 formed in the pump body 12.

Advantageously, each flange 56, 66 comprises at least one keying element which is intended to engage with a complementary keying element formed in the pump body 12, so as to allow only one angular mounting position of the bellows 28 in the pump body 28.

According to the embodiment shown, the keying elements of the flanges 56, 66 are each formed of two opposing notches 74, 76. The notches 74 on the upper flange 56 are radially aligned with the notches 76 on the lower flange 66. The pump body 12 has two axial tongues 78, in the form of cylindrical walls, which extend axially upwards from the base of the pump body 12. These axial tongues 78 here contribute to the axial guidance of the push-button 16, a main axial wall 80 of the push-button 16 being received in the radial space between an axial wall of the pump body 12 and the main axial wall 80 of the push-button 16.

The circumferential dimension of each axial tongue 78 here is substantially equal to the circumferential dimension of each notch 76 formed in the lower flange 66, so as to prevent pivoting about the main axis A1 of the lower flange 66.

Preferably, the bellows 28 is formed of helically wound beads 82, which makes it easier to manufacture by molding, as such a shape is easier to demold.

Due to its helical shape, the axial compression of the bellows 28 during assembly in the dispensing device 10 tends to cause a first relative angular pivoting a1 of the upper flange 56 with respect to the lower flange 66. Axial compression of the bellows 28 when the push-button 16 is actuated then tends to cause a second angular pivoting a2 of the upper flange 56 relative to the lower flange 66.

Since the lower axial end of the bellows 28 is locked against pivoting owing to its tight fit in the annular housing 72, only the upper tubular extension 60 and the upper flange 56 of the bellows 28 pivot.

Advantageously, the direction of rotation of the helical shape of the bellows 28 is opposite the locking direction of the push-button 16, to prevent the pivoting of the upper collar 56 when the bellows 28 is compressed from biasing the push-button 16 in the locking direction when the latter is raised.

Advantageously, to take account of the pivoting of the upper flange 56 when the bellows 28 is compressed, the window 62 extends over a circumferential distance greater than the circumferential dimension of the dispensing duct 18. According to the embodiment shown, the window 62 has an oblong shape that extends circumferentially into the wall of the upper tubular extension 60.

The position of the dispensing duct 18 relative to upper tubular extension 60 and window 62, in an unlocked position of push-button 16, is shown in FIGS. 10 and 11. It can be seen that in the inactive position of FIG. 10, the dispensing duct 18 is offset towards a first circumferential end 81 of the window 62 and, in the lower position of FIG. 11, the dispensing duct 18 is offset towards a second circumferential end 83 of the window 62.

Note that the inlet valve 30 is preferably made from a single piece of elastomer material. It includes an elastically deformable flexible diaphragm, here in the form of a disk, to allow product to pass into the metering chamber 20 when the latter is under vacuum, and to close the chamber inlet 22 during product dispensing or in the inactive position of the dispensing device 10. The inlet valve 30 has a central body 84 which enables it to be force-fitted into a suitable housing on the pump body 12.

An example of such an inlet valve 30 is disclosed and shown, for example, in document WO2018/162850A1.

The dispensing device 10 disclosed and shown in the figures is of the airless type. For this reason, the reservoir 14 features a sliding bottom wall 86, which allows the volume of the reservoir 14 to be adjusted to the volume of product remaining in the reservoir 14.

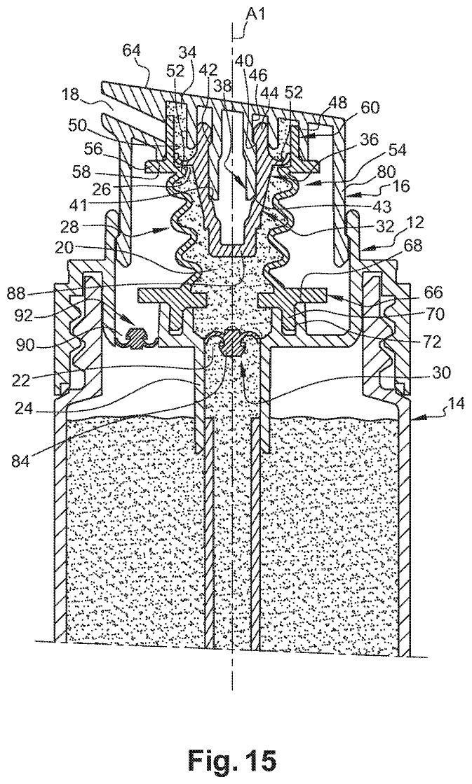

In an alternative embodiment, shown schematically in FIG. 15, the dispensing device 10 applies to a device of the vented type, that is, with an atmospheric pressure port 90. In this case, the atmospheric pressure port 90 can be arranged in the bottom wall of the pump body 12 and fitted with an air vent check valve 92 of the same type as the inlet valve 30, mounted in the opposite direction to allow regulated air entry into the reservoir 14 to replace dispensed product with air.

As shown in the figures, the tubular body 36 of the outlet valve 32 extends downwards into the metering chamber 20 via a closed portion 88. This closed portion 88 allows the outlet valve 32 to fit over the inner cylindrical portion 38 of the push-button 16, reducing the volume of the metering chamber 20.

The operation of the dispensing device 10 according to the invention is now described, considering the various operating stages shown in FIGS. 2 to 8.

FIG. 2 shows the dispensing device 10 in its mechanically and hydraulically locked position. The push-button 16 occupies its locked angular position, wherein the passage between the dispensing duct 18 and the intermediate cavity 34 is closed by the upper tubular extension 60 of the bellows 28, preventing any outward flow of product. In addition, a mechanical locking member (not shown) prevents the push-button 16 from sliding axially downwards. For example, the lower axial ends of the main axial wall 80 of the push-button 16 face an associated stop surface formed in the pump body 12.

It should be noted that the dispensing device 10 has been described here in an already primed configuration, that is, product has already been dispensed, with the product filling the metering chamber 20 and the intermediate cavity 34.

From the position shown in FIG. 2, in order to start dispensing product, a user must rotate the push-button 16 about its axis A1 to its unlocked angular position shown in FIG. 3. This pivoting brings the window 62 in front of the dispensing orifice 18 to allow the product to be expelled outwards.

From the unlocked angular position shown in FIG. 3, the user presses the push-button 16 axially downwards. This axial pressure reduces the volume of the metering chamber 20 and expels product through the chamber outlet 26, owing to the elastic deformation of the outlet valve 32. During this phase, the pressure in the metering chamber 20 rises, preventing the inlet valve 30 from opening.

FIG. 4 shows the start of product dispensing, after a slight axial displacement of the push-button 16, with the product first filling the dispensing duct 18. At the start of this axial downward movement, the outlet flap 32 slides axially by a distance corresponding to its axial travel d1 along the inner cylindrical portion 38 of the push-button 16. During the entire product dispensing process, the outlet valve 32 retains its upper stop position.

FIG. 5 shows the end of product dispensing, when the push-button 16 has reached a lower axial stop position and virtually emptied the metering chamber 20. In this axial position, the outlet valve 32 is still in its upper axial stop position relative to the inner cylindrical portion 38 of the push-button 16.

FIG. 6 shows the start of the ascent of the push-button 16. In this upward phase, under the effect of the elastic upward return exerted by the bellows 28, over an axial distance substantially equal to the axial travel d1, the outlet flap 32 first returns to its lower axial stop position, as shown in FIG. 3. A vacuum is generated inside the bellows 28, causing the outlet valve 32 to move downwards. The relative displacement of the outlet valve 32 with respect to the push-button 16 causes a suction effect in the intermediate cavity 34, since its volume is slightly increased by the relative displacement of the outlet valve 32. This suction phenomenon is used to empty the dispensing duct 18, with the product contained in the dispensing duct 18 filling the volume available in the intermediate cavity 34.

Note that the value of the axial clearance d1 is chosen based on the volume of the dispensing duct 18, so as to be sufficient to ensure complete emptying of the dispensing duct 18.

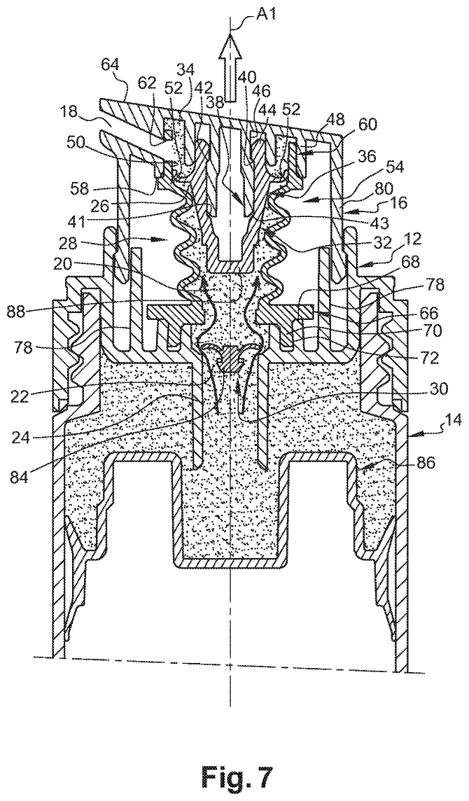

FIG. 7 shows an intermediate stage during the upward movement of push-button 16, showing the opening of the inlet valve 30, owing to the negative pressure generated in the metering chamber 20, and the gradual filling of the metering chamber 20 with product from the reservoir 14.

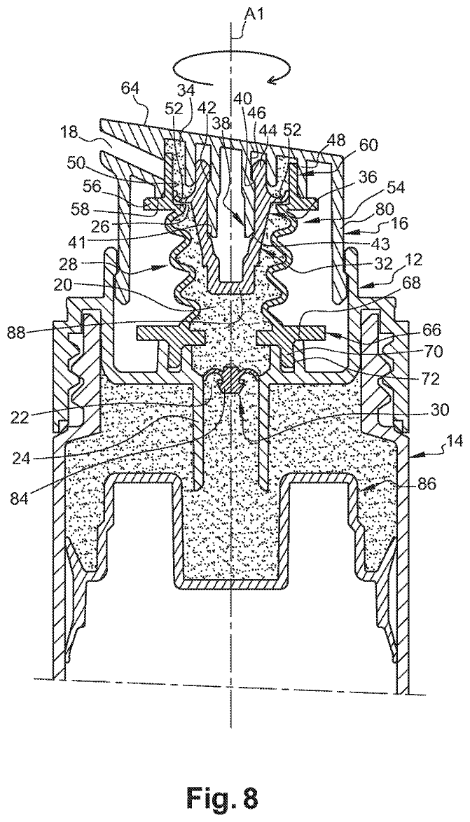

FIG. 8 shows the return of the push-button 16 to a locked angular position, enabling the intermediate cavity 34 to be closed by means of the upper tubular extension 60 of the bellows 28, and isolating the product contained in the intermediate cavity 34 from the outside air.

It should be noted that the hydraulic locking obtained in the locked angular position also prevents the product from escaping in the event of negative pressure outside the dispensing device 10, for example during air travel.

Even in the unlocked position shown in FIG. 3, where the passageway is open to the intermediate cavity 34, the product contained in the intermediate cavity 34 is better protected than when it fills the dispensing duct 18. In fact, the product surface in contact with the air is reduced and distanced from the external end of the dispensing duct 18. In addition, the quantity of product in the volume of the intermediate cavity 34 slows product drying.

### LEGEND

10: dispensing device
12: pump body
13: protective cover
14: reservoir
16: push-button
18: dispensing duct
20: metering chamber
22: chamber inlet
24: supply duct
26: chamber outlet
28: bellows
30: inlet valve
32: outlet valve
34: intermediate cavity
36: tubular body
38: inner cylindrical portion
40, 41: stop surfaces
42, 43: bearing surfaces
44: cylindrical upper end portion
46: annular slot
48: peripheral cylindrical wall
50: peripheral lip
52: inner shoulder portion
54: upper axial end
56: upper flange
58: upper rim
60: upper tubular extension
62: window
64: upper end wall
66: lower flange
68: lower rim
70: lower tubular extension
72: annular housing
74, 76: notches
78: axial tongue
80: main axial wall
81: first circumferential end
82: beading
83: second circumferential end
84: central body
86: bottom wall
88: closed portion
90: atmospheric pressure port
92: air vent check valve
A1: main axis
a1: first angular pivoting
a2: second angular pivoting
d1: axial travel

1. A dispensing device for dispensing liquid to pasty products, comprising:
a pump body intended to be mounted on a product reservoir,
a push-button slidably mounted in the pump body along a main axis between an inactive axial position and a dispensing axial position,
a dispensing duct arranged in the push-button so as to enable a dose of product to be dispensed,
a variable-volume metering chamber comprising a chamber inlet in communication with a supply duct intended to be connected to the reservoir, and a chamber outlet in communication with the dispensing duct,
an elastically deformable bellows which laterally delimits the metering chamber and elastically biases the push-button towards its inactive position,
a first non-return valve, known as an inlet valve, arranged to open or close the chamber inlet under the effect of a pressure decrease or increase, respectively, in the metering chamber,
a second non-return valve, known as an outlet valve, located between the chamber outlet and the dispensing duct,
an intermediate cavity arranged between the dispensing duct and the outlet valve so that a determined amount of product can be stored,
wherein the outlet valve is mounted so as to slide axially on the push-button between an upper position and a lower position, so as to cause a suction effect sucking the product from the dispensing duct towards the intermediate cavity when the push-button slides from its dispensing position to its inactive position.

2. The dispensing device according to claim 1, wherein the outlet valve includes a tubular body which is axially slidably mounted on an internal cylindrical portion of the push-button.

3. The dispensing device according to claim 1, wherein the tubular body includes at least one stop surface intended to engage with an associated bearing surface arranged on the inner cylindrical portion of the push-button in order to define the lower position.

4. The dispensing device according to claim 1, wherein the tubular body and the inner cylindrical portion of the push-button each have an undercut portion which forms the stop surface and the bearing surface, respectively.

5. The dispensing device according to claim 2, wherein the tubular body of the outlet valve includes an upper cylindrical end portion which is axially received in an annular slot delimited inwardly by the inner cylindrical portion and outwardly by a peripheral cylindrical wall of the push-button.

6. The dispensing device according to claim 2, wherein the outlet valve includes a peripheral lip which extends from the outer wall of the tubular body and abuts an associated surface of the bellows in the closed position.

7. The dispensing device according to claim 1, wherein the bellows has at least one internal shoulder portion, on the side of its upper axial end, and in that the peripheral lip rests at least partly on said internal shoulder portion when the push-button occupies a locked angular position.

8. The dispensing device according to claim 1, wherein the bellows comprises an upper flange designed to bear axially against an upper rim formed in the push-button and an upper tubular extension which includes a window designed to be aligned radially with the dispensing duct, in an unlocked angular position of the push-button, and designed to be offset radially with respect to the dispensing duct, in a locked angular position of the push-button, so that the upper tubular extension closes the dispensing duct on the inside in the locked position.

9. The dispensing duct according to claim 1, wherein the upper end wall of the push-button is inclined at a downward slope towards the side opposite the dispensing duct, and in that the upper tubular extension has a beveled shape at its upper free end so that the uppermost part of the upper tubular extension is generally radially aligned with the dispensing duct when the push-button occupies its locked position.

10. The dispensing device according to claim 1, wherein the bellows includes, in the vicinity of its lower end, a lower flange designed to bear axially against a lower rim formed in the pump body, and a lower tubular extension which is tightly fitted in an annular housing formed in the pump body.

11. The dispensing device according to claim 8 taken in combination that wherein each flange comprises at least one keying element which is intended to engage with a complementary keying element formed in the pump body, so as to allow only one angular mounting position of the bellows in the pump body.

12. The dispensing device according to claim 1, wherein the keying elements of the flanges each consist of two opposing notches and in that the notches of the upper flange are radially aligned with the notches of the lower flange.

13. The dispensing device according to claim 1, wherein the pump body has two partially cylindrical axial tongues whose circumferential dimension is substantially equal to the circumferential dimension of each notch formed in the lower flange, so as to prevent pivoting about the main axis of the lower flange.

14. The dispensing device according to claim 1, wherein the bellows is formed of helically wound beads.
